(19) United States
(12) Patent Application Publication
(10) Pub. No.: US 2007/0235118 A1
(43) Pub. Date: Oct. 11, 2007

(54) Vinyl notes

(76) Inventor: Debra Arend, Richmond Heights, MO (US)

Correspondence Address: LATHROP & GAGE LC, 4845 PEARL EAST CIRCLE, SUITE 300, BOULDER, CO, 80301, US

(21) Appl. No.: 11/499,402

(22) Filed: Aug. 4, 2006

Related U.S. Application Data
(60) Provisional application No. 60/705,939, filed on Aug. 5, 2005.

(51) Int. Cl. B31B 1/60

(52) U.S. Cl. 156/60

(57) ABSTRACT

A method for making notes includes providing a sheet having first indicia printed thereon according to a predetermined motif that invites a manual written response from a user for placement of second indicia on the sheet, using an electrostatic interaction to removably affix the sheet to a foreign surface, and placing the second indicia on the sheet. A method of making notes regarding a beverage includes providing a beverage in a container, providing a vinyl sheet having a predetermined motif printed thereon, adding indicia to the sheet, and using an electrostatic interaction to removably affix the sheet to the container. A device for use in making notes includes a vinyl sheet to affix to a foreign surface through an electrostatic interaction. The sheet has first indicia printed thereon according to a predetermined motif that invites a manual written response from a user for placement of second indicia on the sheet.

### RELATED APPLICATIONS

This application claims benefit of U.S. Provisional Patent Application 60/705,939, filed Aug. 5, 2005.

### BACKGROUND

1. Field of the Invention

The present invention pertains to notes that are made of static cling vinyl and the like. More particularly, the notes are configured with indicia that invites a user to enter a manual response according to a predetermined motif or theme of action.

2. Description of the Related Art

Static cling vinyls are available on commercial order from a variety of sources. These materials are generally a special formulation of polyvinyl chloride (PVC) that has been made flexible by the addition of plasticizer. The static cling vinyls advantageously stick to a variety of smooth, hard surfaces without requiring the use of adhesive for this purpose. By way of example, a static cling vinyl may be selectively positioned and repositioned on glass without smearing the glass with adhesive residue. As is known in the art, various methods may be used for printing indicia on static cling vinyl, including screen printing, UV offset printing, UV flexography printing, and thermal transfer printing. Generally, these are machine techniques where the art fails to appreciate the potential of static cling vinyls in notemaking. An example of the prior art may be seen in U.S. Pat. No. 6,595,632.

### SUMMARY

The present instrumentalities overcome the problems outlined above and advance the art by providing a static cling vinyl that is configured with indicia according to a predetermined motif that invites a user to enter a manual response and/or perform an action.

In one aspect, the indicia presents a static cling sheet or note bearing first indicia in a machine printed format. This first indicia is machine printed according to a predetermined motif that invites a manual written response from a user for placement of second indicia on the sheet. A first user may place the note on a surface that is amenable to electrostatic interaction with the static cling vinyl for positioning and retention of the note on the surface. The first indicia is such that it invites one of the first user and a second user to enter second indicia on the note. Exemplary embodiments may include the motif of the first indicia as providing a format for entry of a to-do list, love note, or request for service.

In a particularly preferred embodiment, the motif is a request for entry of second indicia that pertains to the tasting of an alcoholic beverage, and especially second indicia describing the nature of wine. The static cling vinyl may be constructed and arranged as a flat sheet that is sufficiently flexible to adapt and confirm to the curvature of a bottle, or may be provided with geometric contours that enhance the ability of the static cling vinyl to adapt and conform to the bottle for purposes of the static cling interaction. By way of example, the sheet may present a concave-convex structure that is adapted for positioning on the neck of a bottle.

### BRIEF DESCRIPTION OF THE DRAWINGS

FIG. 1 shows a front view of a vinyl note having a wine motif positioned on a bottle.

FIG. 2 shows a front view of another vinyl note having a wine motif positioned on a bottle.

FIG. 3A shows a front view of still another vinyl note positioned on a bottle.

FIG. 3B shows a perspective view of the vinyl note as in FIG. 3A.

FIG. 4 shows a perspective view of yet another vinyl note positioned on a bottle.

FIG. 5 shows a perspective view of still yet another vinyl note positioned on a bottle.

FIGS. 6-10 show front views of vinyl notes.

FIG. 11 shows a front view of a book of vinyl notes as in FIG. 1.

FIG. 12 shows a sectional view taken from FIG. 11.

FIG. 13 shows a perspective view of the book of vinyl notes as in FIG. 11.

FIG. 14 shows a front view of another book of vinyl notes.

FIG. 15 shows a sectional view taken from FIG. 14.

FIG. 16 shows a perspective view of the book of vinyl notes as in FIG. 14.

FIG. 17 shows a front view of still another book of vinyl notes.

FIG. 18 shows a sectional view taken from FIG. 17.

FIG. 19 shows a perspective view of the book of vinyl notes as in FIG. 17.

FIG. 20 shows a flow chart illustrating a process for making notes.

FIG. 21 shows another flow chart illustrating a process for making notes.

### DESCRIPTION OF THE PREFERRED EMBODIMENT

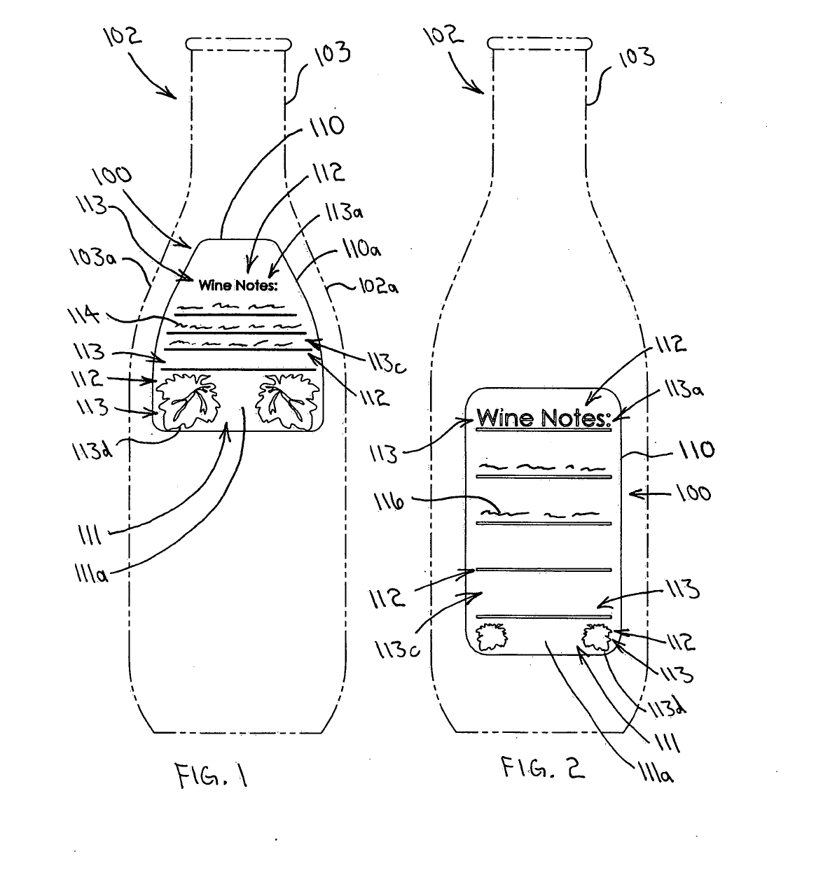

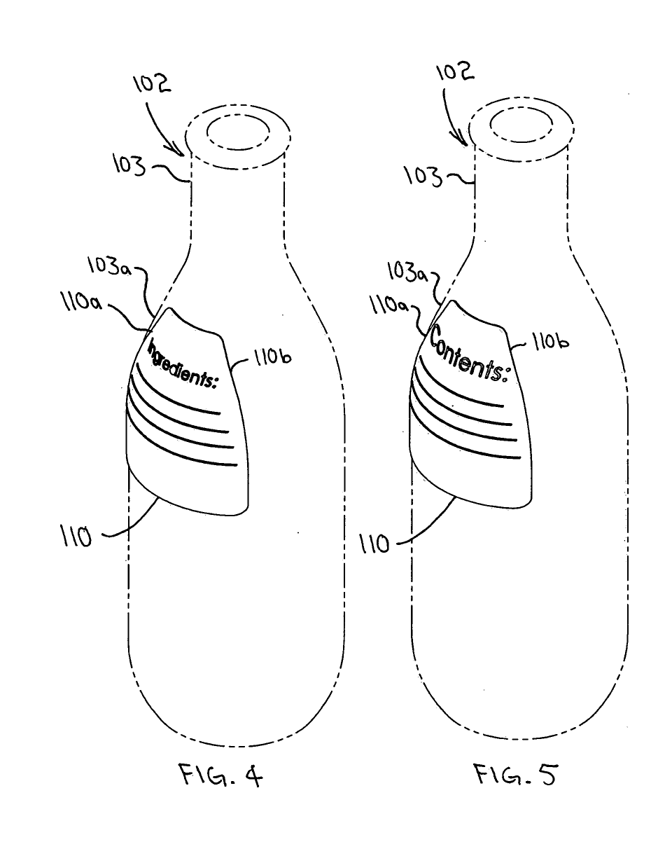

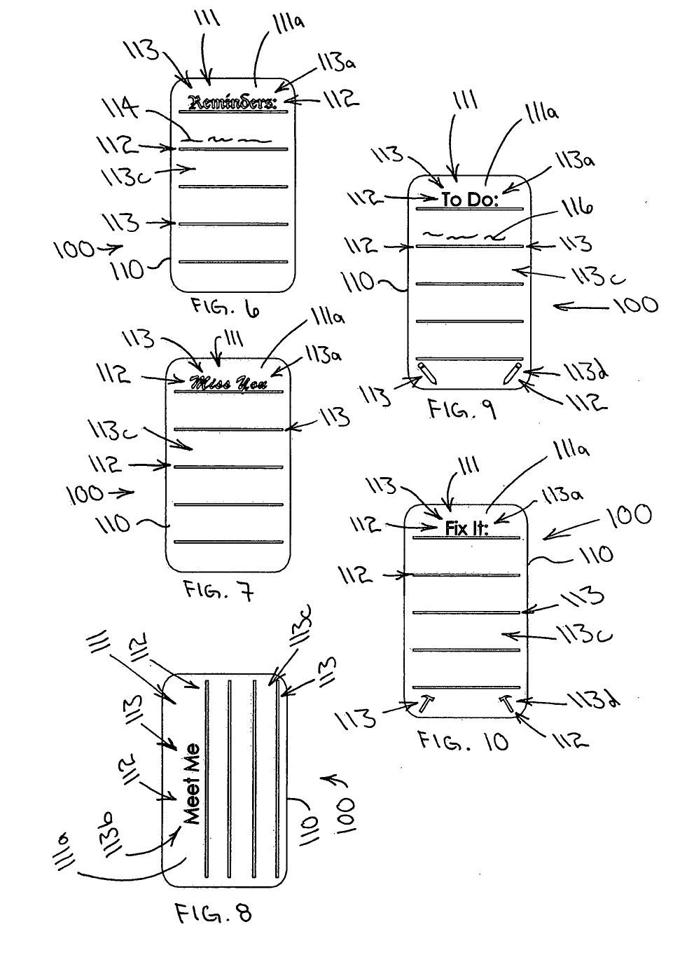

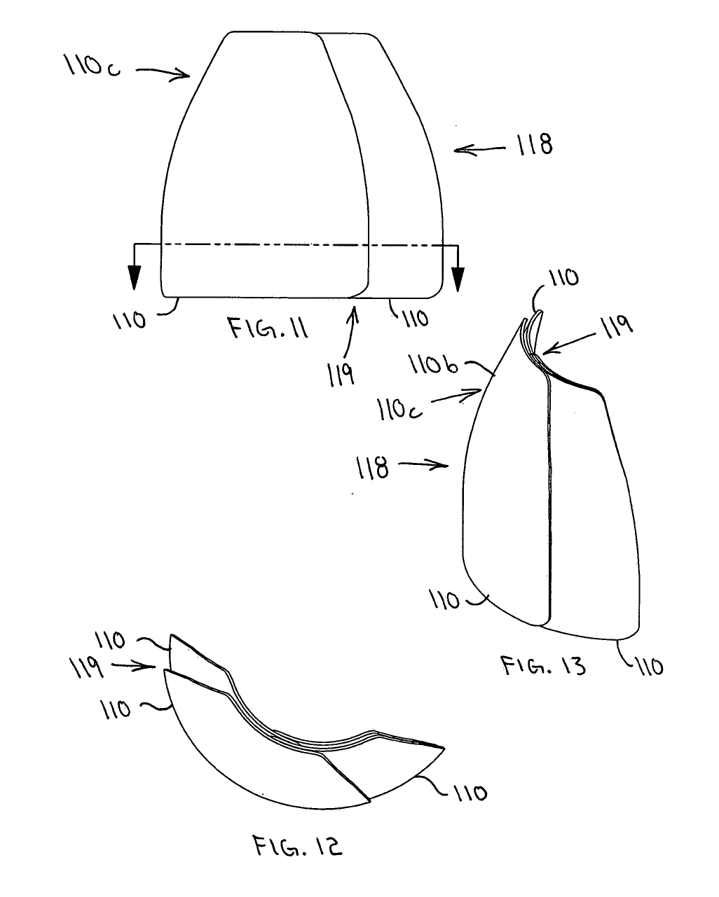

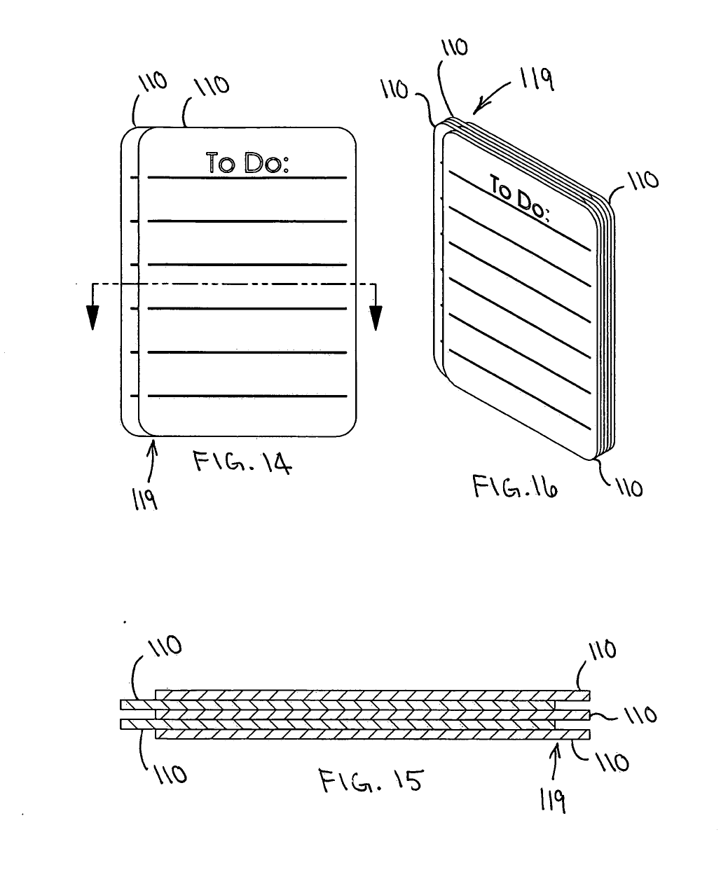

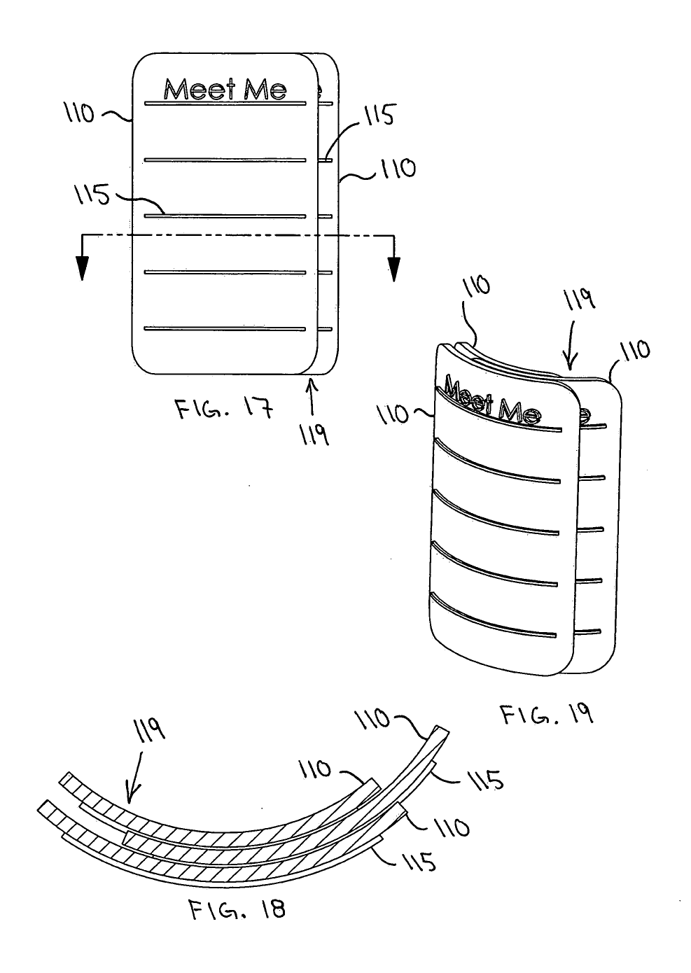

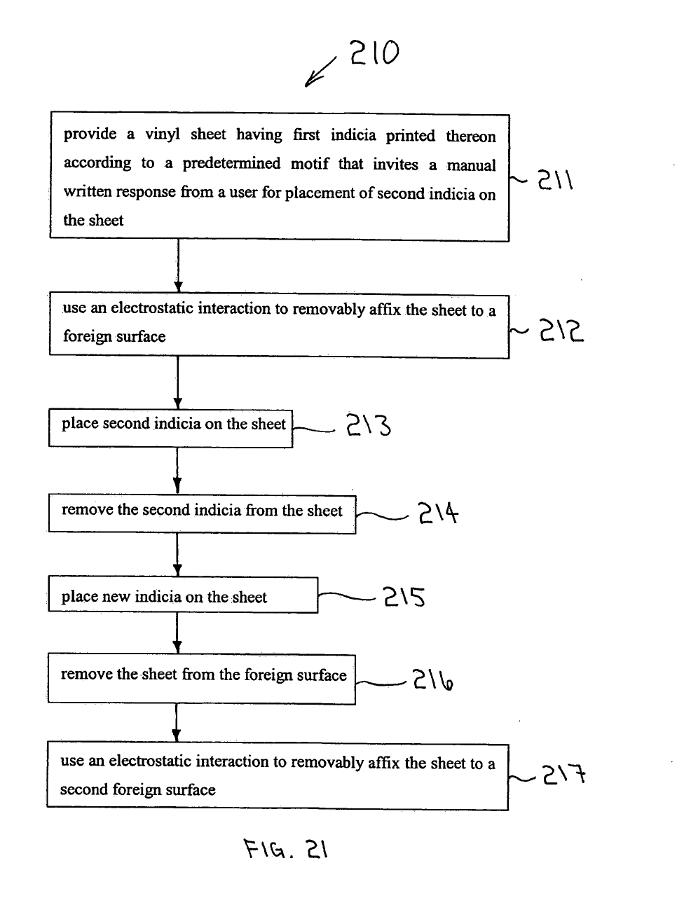

A device and method for making notes according to the present invention will now be described in detail with reference to FIGS. 1 through 22 of the accompanying drawings. More particularly, a device 100 for use in making notes comprises a vinyl sheet 110 to affix to a foreign surface 102 through an electrostatic interaction (FIGS. 1 through 5). The sheet 110 has first indicia 112 printed thereon according to a predetermined motif 111 that invites a manual written response from a user for placement of second indicia 114 on the sheet 110 (FIGS. 1 through 10).

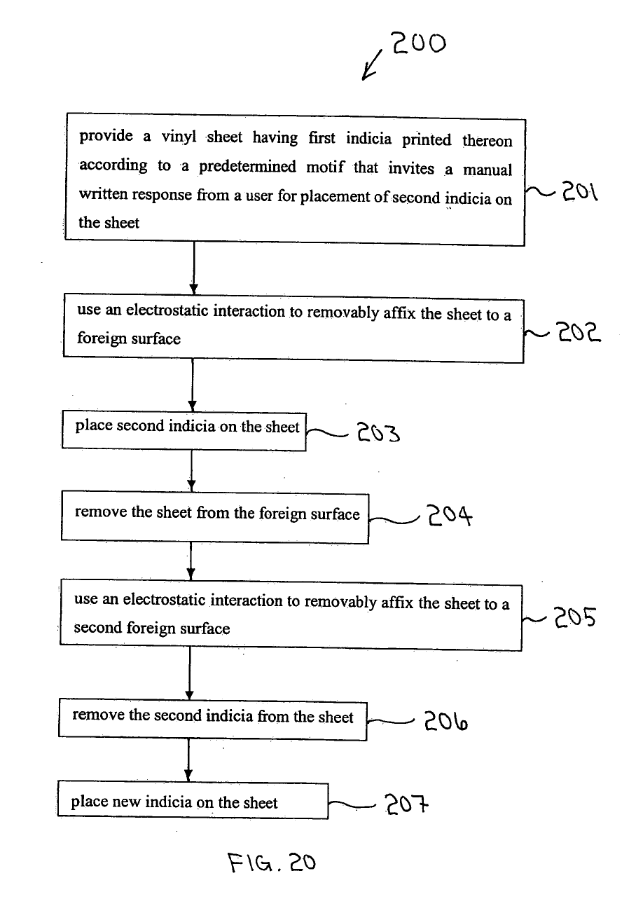

The predetermined motif 111 includes printed words and ornamental design unified by a concept such as a solicitation of information, a task, or an emotional state. The predetermined motif 111 is preferably a wine motif that includes printed words and ornamental design unified by a wine theme inviting the user to write wine notes as the second indicia 114, as seen in FIGS. 1 and 2. The predetermined motif 111 is preferably a data field 111a that includes a plurality of elements 113. Elements 113 may include a heading 113a, a request 113b, data entry space 113c, and an ornamental design 113d. The elements 113 cooperatively invite the user to place the second indicia 114 in the data entry space 113c. The data entry space 113c may include lines 115 that are physically raised from the data field 111a, as shown in FIGS. 17 through 19. The sheet 110 may be manufactured to include the lines 115, or the lines 115 may be attached to the sheet 110 after the sheet 110 is manufactured using an adhesive or other attachment method.

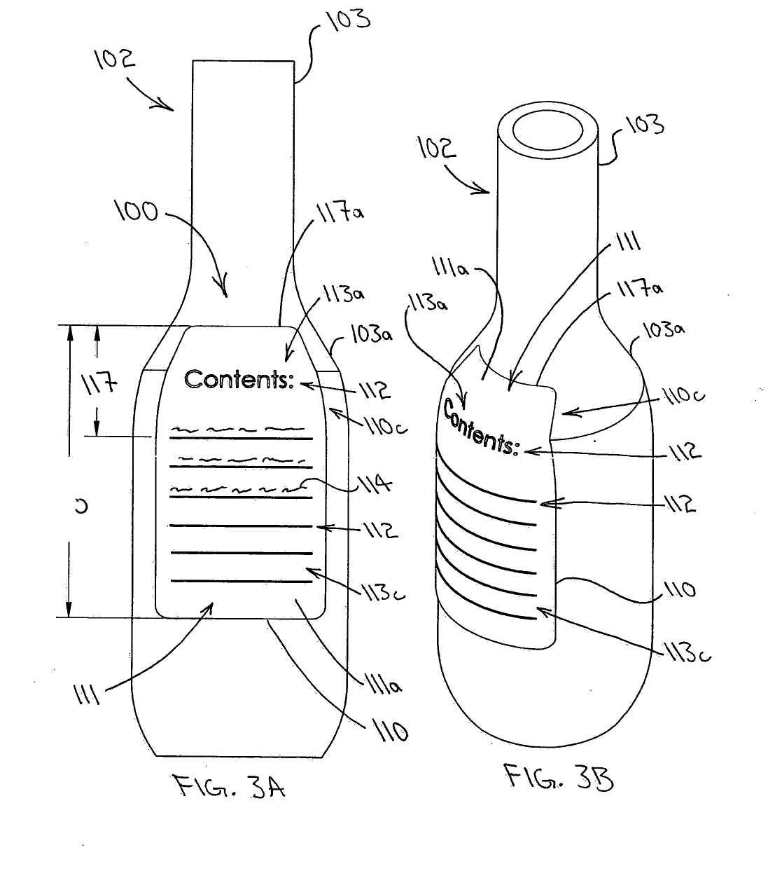

The foreign surface 102 is preferably a wine bottle 103 as shown in FIGS. 1 through 5, though other containers and flat surfaces could be utilized, and the sheet 110 preferably has a curved configuration 110a complementary to a configuration 102a of the wine bottle 103 (FIGS. 1 and 3 through 5). More particularly, as shown in FIGS. 1, 3-5, and 11-13, the sheet 110 may have geometric contours 110b that enhance the ability of the static cling vinyl to adapt and conform to the bottle 103 for purposes of the static cling interaction. The configuration 110a of the sheet 110 may include a tapered concave-convex configuration 110c (FIGS. 11 and 13) that is adapted for positioning on a neck 103a of the bottle 103, as shown in FIGS. 1 and 3 through 5. In other words, the tapered concave-convex configuration 110c may accommodate a complementary curvature in the neck 103a of the wine bottle 103. This tapered concave-convex configuration 110c may be located within an upper section 117 of the sheet 110, and the tapered concave-convex configuration 110c may be located within one-third of the height 120 of the sheet 110 from an upper edge 117a of the sheet 110. This location of the concave-convex configuration 110c allows the sheet 110 to securely attach to the neck 103a of a Bordeaux Bottle 103 (FIGS. 3A and 3B) and provides a large data entry space 113c that is not located on the bottle's neck 103a, which makes it easier for the user to add the second indicia 114. The Bordeaux Bottle 103 (shown in FIGS. 3A and 3B) has a more aggressively-sloping neck 103a than other bottles 103, such as the Burgundy Bottles 103 shown in FIGS. 1, 2, 4, and 5. Alternately, the sheet 110 may be a flat sheet that is sufficiently flexible to adapt and conform to the curvature of the bottle 103, as shown in FIG. 2.

As shown in FIGS. 11 through 19, a book 118 preferably contains a plurality of sheets 110, and the plurality of sheets 110 are preferably affixed into the book 118 in an alternating offset configuration 119 by a plurality of electrostatic interactions between the sheets 110. The alternating offset configuration 119 allows a sheet 110 to be easily separated from the book 118.

A method 200 of making notes is illustratively shown in FIG. 20.

At step 201, the sheet 110 is provided. The sheet 110 is preferably provided by separating the sheet 110 from the book 118. The process then continues to step 202.

At step 202, an electrostatic interaction may be used to removably affix the sheet 110 to the foreign surface 102. The process then continues to step 203.

At step 203, the user may place the second indicia 114 on the sheet 110, such as by writing on the sheet 110 with a marker containing water-soluble ink. The process then continues to step 204.

At step 204, the user may remove the sheet 110 from the foreign surface 102 by simply pulling the sheet 110 from the foreign surface 102 to overcome the electrostatic interaction. Since the sheet 110 was attached to the foreign surface 102 by an electrostatic interaction, there is no residue when the sheet 110 is removed. The process then continues to step 205.

At step 205, an electrostatic interaction may be used to removably affix the sheet 110 to a second foreign surface 102. The process then continues to step 206.

At step 206, the second indicia 114 may be removed from the sheet 110. The sheet 110 may be wiped with a dry cloth or a damp cloth to remove the second indicia 114. The process then continues to step 207.

At step 207, new indicia 116 (FIG. 2) may be placed on the sheet 110, such a by writing on the sheet 110 with a marker containing water-soluble ink.

According to another embodiment, a method 210 of making notes is illustratively shown in FIG. 21.

At step 211, the sheet 110 is provided. The sheet 110 is preferably provided by separating the sheet 110 from the book 118. The process then continues to step 212.

At step 212, an electrostatic interaction may be used to removably affix the sheet 110 to the foreign surface 102, which is preferably the wine bottle 103. The process then continues to step 213.

At step 213, the user may place the second indicia 114 on the sheet 110, such as by writing on the sheet 110 with a marker containing water-soluble ink. The second indicia 114 is preferably a note about wine in the wine bottle 103. The process then continues to step 214.

At step 214, the second indicia 114 may be removed from the sheet 110. The sheet 110 may be wiped with a dry cloth or a damp cloth to remove the second indicia 114. The process then continues to step 215.

At step 215, new indicia 116 may be placed on the sheet 110, such as by writing on the sheet 110 with a marker containing water-soluble ink. The process then continues to step 216.

At step 216, the user may remove the sheet 110 from the foreign surface 102 by simply pulling the sheet 110 from the foreign surface 102 to overcome the electrostatic interaction. The process then continues to step 217.

At step 217, an electrostatic interaction may be used to removably affix the sheet 110 to a second foreign surface 102. The second foreign surface 102 may be a wine bottle 103, a notebook page, or another smooth surface.

It is understood that while certain forms of this invention have been illustrated and described, it is not limited thereto except insofar as such limitations are included in the following claims and allowable functional equivalents thereof.

What is claimed is as follows:

1. A method of making notes, comprising:
providing a vinyl sheet having first indicia printed thereon according to a predetermined motif that invites a manual written response from a user for placement of second indicia on said sheet;
using an electrostatic interaction to removably affix said sheet to a foreign surface; and
the user placing the second indicia on said sheet.

2. The method as in claim 1, further comprising:
removing said sheet from said foreign surface; and
using an electrostatic interaction to removably affix said sheet to a second foreign surface.

3. The method as in claim 1, further comprising:
removing said second indicia from said sheet; and
placing new indicia on said sheet.

4. The method as in claim 1, wherein said predetermined motif includes printed words and ornamental design unified by a concept selected from a group consisting of a solicitation of information, a task, and an emotional state.

5. The method as in claim 1, wherein said predetermined motif is a wine motif that includes printed words and ornamental design unified by a wine theme inviting the user to write wine notes as the second indicia.

6. The method as in claim 5, wherein said foreign surface is a wine bottle.

7. The method as in claim 6, wherein said sheet has a curved configuration complementary to a configuration of said bottle.

8. The method as in claim 7, further comprising:
removing said second indicia from said sheet; and
placing new indicia on said sheet.

9. The method as in claim 1, wherein:
said foreign surface is a bottle; and
said sheet has a curved configuration complementary to a configuration of said bottle.

10. The method as in claim 1, wherein said sheet is provided by separating said sheet from a book containing a plurality of said sheets.

11. The method as in claim 10, wherein said plurality of said sheets are affixed into said book by a plurality of electrostatic interactions between said sheets.

12. The method as in claim 11, wherein said plurality of said sheets are affixed into said book in an alternating offset configuration.

13. The method as in claim 1, wherein:
said foreign surface is a bottle;
said sheet has an upper edge and a height; and
said sheet has a tapered concave-convex configuration located within one-third of said height from said upper edge.

14. A method of making notes regarding a beverage, comprising:
providing a beverage in a container;
providing a vinyl sheet having a predetermined motif printed thereon;
adding indicia to said sheet; and
using an electrostatic interaction to removably affix said sheet to said container.

15. The method as in claim 14, wherein said motif includes printed words and ornamental design unified by the concept of soliciting information about said beverage.

16. The method as in claim 15, further comprising:
removing said indicia from said sheet; and
placing new indicia on said sheet.

17. The method as in claim 16, further comprising:
removing said sheet from said container;
using an electrostatic interaction to removably affix said sheet to a remote surface;
wherein said container is a bottle; and
wherein said sheet is provided by separating said sheet from a book containing a plurality of said sheets, said sheets being affixed into said book in an alternating offset configuration by a plurality of electrostatic interactions between said sheets.

18. The method as in claim 17, wherein said sheet has a curved configuration complementary to a configuration of said bottle.

19. The method as in claim 17, wherein:
said sheet has an upper edge and a height; and
said sheet has a tapered concave-convex configuration located within one-third of said sheet height from said sheet upper edge to accommodate a complementary curvature in a neck of said bottle.

20. A device for use in making notes, comprising a vinyl sheet to affix to a foreign surface through an electrostatic interaction, said sheet having first indicia printed thereon according to a predetermined motif that invites a manual written response from a user for placement of second indicia on said sheet.

21. The device as in claim 20, wherein said predetermined motif is a data field that includes a plurality of elements, said plurality of elements including a data entry space and at least one element chosen from the group consisting of a heading, a request, and an ornamental design.

22. The device as in claim 20, wherein said predetermined motif is a wine motif that includes printed words and ornamental design unified by a wine theme inviting the user to write wine notes as the second indicia.

23. The device as in claim 22, wherein:
said container is a wine bottle; and
said sheet has a curved configuration complementary to a configuration of said bottle.

24. The device as in claim 20, wherein said sheet is provided by separating said sheet from a book containing a plurality of said sheets.

25. The device as in claim 24, wherein said plurality of said sheets are affixed into said book by a plurality of electrostatic interactions between said sheets.

26. The device as in claim 25, wherein said plurality of said sheets are affixed into said book in an alternating offset configuration.

27. A method of making notes, comprising:
providing a vinyl sheet having means for inviting a manual written response from a user for placement of indicia on said sheet;
using an electrostatic interaction to removably affix said sheet to a foreign surface; and
the user placing said indicia on said sheet.

28. The method as in claim 27, further comprising:
removing said sheet from said foreign surface; and
using an electrostatic interaction to removably affix said sheet to a second foreign surface.

29. The method as in claim 27, further comprising:
removing said indicia from said sheet; and
placing new indicia on said sheet.

30. The method as in claim 27, wherein:
said foreign surface is a bottle having a curved neck; and
said vinyl sheet includes means for accommodating said curved neck to allow said vinyl sheet to attach to said curved neck.
